(19) United States
(12) Patent Application Publication
(10) Pub. No.: US 2026/0322635 A1
(43) Pub. Date: Oct. 15, 2026

(54) METHOD AND APPARATUS FOR PROVIDING IDENTIFICATION INFORMATION FOR ANIMALS USING BLOCKCHAIN-BASED NFTS

(71) Applicant: YCONS CO.,LTD, Seoul (KR)

(72) Inventor: Seungil KIM, Seoul (KR)

(21) Appl. No.: 19/688,530

(22) Filed: May 27, 2026

Related U.S. Application Data
(63) Continuation of application No. PCT/KR2024/014266, filed on Sep. 23, 2024.

(30) Foreign Application Priority Data
Nov. 27, 2023 (KR) 10-2023-0166301

(51) Int. Cl. H04L 9/00

(52) U.S. Cl. CPC H04L 9/50

(57) ABSTRACT

A method for providing identification information for animals using a blockchain-based NFT (non-fungible token), performed by a computing device according to an embodiment, may include uploading information indicating whether an electronic registration associated with identification information of a target animal has been issued to a predetermined first blockchain network, uploading proof information regarding a first NFT generated by being added to the first blockchain network and the identification information of the target animal to a predetermined second network, and transmitting a recognition code including access information for the second network to a user terminal.

### CROSS-REFERENCE TO RELATED APPLICATION

This application is a U.S. Bypass Continuation Application of International Application No. PCT/KR 2024/014266, filed on Sep. 23, 2024, which claims priority to and the benefit of Korean Patent Application No. 10-2023-0166301, filed on Nov. 27, 2023, the disclosure of which is incorporated herein by reference in its entirety.

### BACKGROUND

### Technical Field

The following embodiments relate to a method and apparatus for providing identification information for animals using blockchain-based NFTs. More particularly, the following embodiments relate to a method and apparatus for providing identification information for animals by uploading, to different respective networks, information indicating whether an electronic registration relating to identification information of an animal has been issued, an NFT generated by uploading the information, and identification information of the animal.

### Background Art

As population aging deepens, social factors such as an increase in the proportion of single-person households and changes in awareness of companion animals have caused the proportion of households raising companion animals to increase exponentially. As the number of households raising companion animals increases, industries relating to companion animals, such as animal hospitals, medical devices, and various insurance products, are also rapidly growing. While interest in companion animals is increasing, many cases of loss or abandonment of companion animals occur, and once an animal is lost or abandoned, it is not easy for the animal to be returned to its owner.

In order to solve these problems and manage companion animals, there is an increasing demand for services that define animal identification information, such as a human fingerprint, and store and provide animal identification information using the same. Specifically, in the case of dogs, because nose prints (the shapes of nose wrinkles) are different from one dog to another, the nose print of each dog may be used as identification information.

### SUMMARY

A technical problem to be solved by the technical idea of the present disclosure is to manage animal information including identification information for an animal. Specifically, information indicating whether an electronic registration relating to identification information of an animal has been issued, an NFT generated by uploading the information, and identification information of the animal may be uploaded to different respective networks. In particular, an object is to provide a method for providing identification information for animals with high security by uploading respective information to different networks.

Another object is to provide a method for providing identification information for animals by which information including animal identification information, such as a nose print of a companion animal, is uploaded and companion animal information can be checked using the identification information, so that even when the companion animal is lost, the owner can be found more quickly.

In particular, information indicating whether an electronic registration relating to identification information of an animal has been issued is uploaded to a blockchain network using blockchain technology, which has a low risk of damage to or manipulation of information, thereby further increasing security.

A method for providing identification information for animals using a blockchain-based NFT (non-fungible token), performed by a computing device according to an embodiment, may include uploading information indicating whether an electronic registration associated with identification information of a target animal has been issued to a predetermined first blockchain network, uploading proof information regarding a first NFT generated by being added to the first blockchain network and the identification information of the target animal to a predetermined second network, and transmitting a recognition code including access information for the second network to a user terminal.

According to an embodiment, the proof information regarding the first NFT may include at least one of protocol information of the first blockchain network, identification information of the first NFT, a smart contract address of the first blockchain network, access information of the first NFT, registration information of the first NFT, and a hash value of the first blockchain network.

According to an embodiment, the identification information of the target animal may include at least one of a type of the target animal, a registered owner of the target animal, lineage information of the target animal, and image data of the target animal.

According to an embodiment, when image data of a lost animal is received from a requester terminal, the method may include extracting feature data of the lost animal, confirming whether an NFT including the feature data exists among a plurality of NFTs stored in the second network, when an NFT including the feature data exists in the second network, transmitting a confirmation message to an owner terminal, and when no NFT including the feature data exists in the second network, transmitting an unregistered notification message to the requester terminal.

According to an embodiment, when a registration for a parent of the target animal exists, the method may include uploading a fact of authentication of information on a parental lineage of the target animal to the first blockchain network, and uploading, to the predetermined second network, additional proof information regarding a second NFT generated by being added to the first blockchain network and access information for an NFT of a parent of the target animal.

According to an embodiment, when image data of a lost animal is received from a requester terminal, the step of extracting feature data of the lost animal may include extracting a nose region from the received image data and extracting feature points by analyzing a histogram of the nose region.

The apparatus for providing identification information for animals according to the present disclosure may upload companion animal information including identification information for an animal, and may upload, to different respective networks, information indicating whether an electronic registration relating to identification information of the animal has been issued, an NFT generated by uploading the information, and identification information of the animal. Through this, capacity and processing speed problems can be solved.

In addition, information including animal identification information, such as a nose print of a companion animal, may be uploaded, and access information therefor may be provided.

According to another embodiment, nose print information of a lost animal can be checked, and accessibility and security can be increased by distributed uploading to different networks.

In particular, information indicating whether an electronic registration relating to identification information of an animal has been issued is uploaded to a blockchain network using blockchain technology, which has a low risk of damage to or manipulation of information, thereby further increasing security.

### BRIEF DESCRIPTION OF THE DRAWINGS

FIG. 1 is a flowchart for describing a method for providing identification information for animals according to an embodiment.

FIG. 2 is an exemplary diagram for describing a system in which an apparatus for providing identification information for animals using a blockchain-based NFT (non-fungible token) according to an embodiment operates.

FIGS. 3 to 6 are exemplary diagrams for describing information uploaded to an apparatus for providing identification information for animals according to an embodiment.

FIG. 7 is an exemplary diagram for describing a step of extracting feature data for an animal according to an embodiment.

### DETAILED DESCRIPTION

Specific structural or functional descriptions of embodiments according to the concept of the present invention disclosed in this specification are merely illustrative for the purpose of describing the embodiments according to the concept of the present invention, and the embodiments according to the concept of the present invention may be implemented in various forms and are not limited to the embodiments described in this specification.

Since the embodiments according to the concept of the present invention may have various modifications and may have various forms, the embodiments are illustrated in the drawings and described in detail in this specification. However, this is not intended to limit the embodiments according to the concept of the present invention to specific disclosed forms, and includes modifications, equivalents, or substitutes included in the spirit and technical scope of the present invention.

Terms such as first or second may be used to describe various components, but the components should not be limited by the terms. The terms are used only for the purpose of distinguishing one component from another component. For example, without departing from the scope of rights according to the concept of the present invention, a first component may be named a second component, and similarly, the second component may also be named the first component.

When a component is referred to as being “connected” or “coupled” to another component, it should be understood that the component may be directly connected or coupled to the other component, but that another component may be present therebetween. On the other hand, when a component is referred to as being “directly connected” or “directly coupled” to another component, it should be understood that no other component is present therebetween. Expressions describing relationships between components, such as “between” and “directly between” or “directly adjacent to,” should be interpreted in the same manner.

The terminology used in this specification is used only for describing particular embodiments and is not intended to limit the present invention. Singular expressions include plural expressions unless the context clearly indicates otherwise. In this specification, terms such as “comprise” or “have” should be understood to specify the presence of stated features, numbers, steps, operations, components, parts, or combinations thereof, and not to preclude in advance the presence or addition of one or more other features, numbers, steps, operations, components, parts, or combinations thereof.

Unless otherwise defined, all terms used herein, including technical or scientific terms, have the same meaning as generally understood by a person having ordinary skill in the art to which the present invention pertains. Terms such as those defined in commonly used dictionaries should be interpreted as having meanings consistent with their meanings in the context of the related art, and unless clearly defined in this specification, should not be interpreted in an idealized or excessively formal sense.

A module in this specification may mean hardware capable of performing a function and an operation according to each name described in this specification, may mean computer program code capable of performing a specific function and operation, or may mean an electronic recording medium, for example, a processor or a microprocessor, on which computer program code capable of performing a specific function and operation is loaded.

In other words, a module may mean a functional and/or structural combination of hardware for carrying out the technical idea of the present invention and/or software for driving the hardware.

Hereinafter, embodiments will be described in detail with reference to the accompanying drawings. However, the scope of the patent application is not limited or restricted by these embodiments. The same reference numerals shown in the drawings denote the same members.

A method for providing identification information for animals using a blockchain-based NFT (non-fungible token), performed by a computing device according to an embodiment of the present application, is for managing animal information including identification information for an animal. Specifically, information indicating whether an electronic registration relating to identification information of an animal has been issued, an NFT generated by uploading the information, and identification information of the animal may be uploaded to different respective networks. In particular, an object is to provide a method for providing identification information for animals with high security by uploading respective information to different networks.

In addition, information including animal identification information, such as a nose print of a companion animal, may be uploaded, and companion animal information may be checked using the identification information, thereby providing a method for providing identification information for animals by which, even when the companion animal is lost, the owner can be found more quickly.

In particular, information indicating whether an electronic registration relating to identification information of an animal has been issued is uploaded to a blockchain network using blockchain technology, which has a low risk of damage to or manipulation of information, thereby further increasing security.

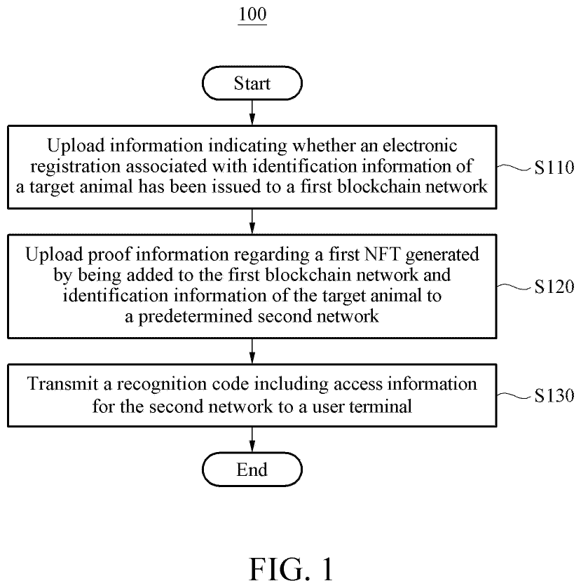

FIG. 1 is a flowchart for describing a method for providing identification information for animals according to an embodiment.

Referring to FIG. 1, an apparatus for providing identification information for animals may upload information indicating whether an electronic registration associated with identification information of a target animal has been issued to a predetermined first blockchain network (S110), upload proof information regarding a first NFT generated by being added to the first blockchain network and the identification information of the target animal to a predetermined second network (S120), and transmit a recognition code including access information for the second network to a user terminal (S130).

According to an embodiment, in step (S110), the apparatus for providing identification information for animals may upload information indicating whether an electronic registration associated with identification information of a target animal has been issued to the predetermined first blockchain network.

According to an embodiment, the identification information of the target animal may be generated from an owner of the target animal. The owner may be issued an electronic registration including the identification information of the target animal. When the owner receives the electronic registration, the apparatus for providing identification information for animals may upload information indicating whether the electronic registration has been issued to the first blockchain network.

The first blockchain network may mean a distributed database based on blockchain technology.

The identification information of the animal may include at least one of a type of the target animal, a registered owner of the target animal, lineage information of the target animal, and image data of the target animal.

According to an embodiment, in step (S120), the apparatus for providing identification information for animals may upload, to the predetermined second network, first NFT information generated by being added to the first blockchain network in step (S110) and the identification information of the target animal.

According to an embodiment, the apparatus for providing identification information for animals may acquire a first NFT associated with information indicating whether the electronic registration has been issued by uploading the information to the first blockchain network.

An NFT (non-fungible token) is a virtual token proving an owner of a digital asset using blockchain technology, and may be used to indicate unique originality and ownership by including, in the token, an address indicating a digital file such as a picture or video. That is, according to an embodiment, when an NFT for indicating ownership information regarding the target animal is generated, originality or ownership of the electronic registration associated with the identification information of the animal can be guaranteed using the permanent NFT. In addition, because the first NFT relates to information indicating whether the electronic registration associated with the identification information of the animal has been issued, the data size may be relatively small.

According to an embodiment, the apparatus for providing identification information for animals may upload the first NFT information and the identification information of the target animal to the second network. The second network may be a public server network.

That is, the apparatus for providing identification information for animals may upload information indicating whether an electronic registration associated with identification information of a target animal has been issued to the first blockchain network, and may upload proof information regarding the first NFT generated by being added to the first blockchain network and the identification information of the target animal to the second network. By uploading information to the respective different networks, the apparatus for providing identification information for animals may provide higher security and storage efficiency.

According to an embodiment, in step (S130), the apparatus for providing identification information for animals may transmit a recognition code including access information for the second network to the user terminal. Specifically, the apparatus for providing identification information for animals may transmit, to the user terminal, a recognition code including access information for the second network, such as a QR code or a barcode.

According to an embodiment, a user may more conveniently access the second network using the transmitted recognition code, and may check first NFT information generated by being added to the first blockchain network and the identification information of the target animal. In addition, the user may share the transmitted recognition code, thereby safely sharing the identification information of the target animal with another person.

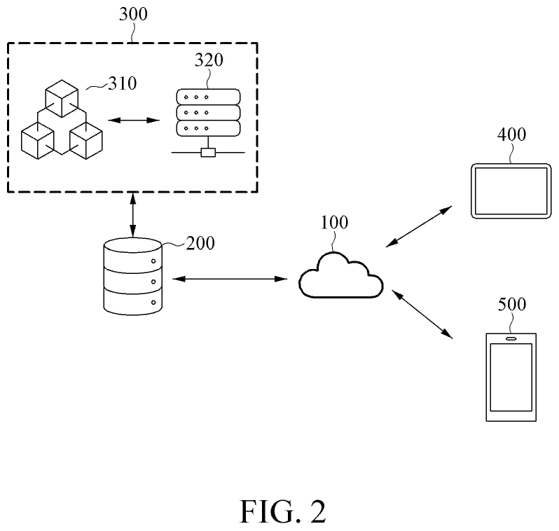

FIG. 2 is an exemplary diagram for describing a system in which an apparatus for providing identification information for animals using a blockchain-based NFT (non-fungible token) according to an embodiment operates.

Referring to FIG. 2, a system in which the apparatus for providing identification information for animals using a blockchain-based NFT (non-fungible token) operates may include a communication network 100, an apparatus 200 for providing identification information for animals, a network database 300, a user terminal 400, and a requester terminal 500.

The communication network 100, the apparatus 200 for providing identification information for animals, the network database 300, the user terminal 400, and the requester terminal 500 may each be connected to a communication network and may transmit and receive data to and from one another through the communication network. For example, as the communication network, various types of wired or wireless networks may be used, such as a LAN (Local Area Network), a MAN (Metropolitan Area Network), a GSM (Global System for Mobile Network), EDGE (Enhanced Data GSM Environment), HSDPA (High Speed Downlink Packet Access), W-CDMA (Wideband Code Division Multiple Access), CDMA (Code Division Multiple Access), TDMA (Time Division Multiple Access), Bluetooth, Zigbee, Wi-Fi, VoIP (Voice over Internet Protocol), LTE Advanced, IEEE 802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), Wi-MAX (World Interoperability for Microwave Access), 5G, and the like.

The communication network 100 may include wired Internet including a leased line, wireless Internet, a mobile communication network, a satellite communication network, and the like.

The apparatus 200 for providing identification information for animals may mean an apparatus that mainly performs the method for providing identification information for animals according to an embodiment of the present invention. That is, the apparatus 200 for providing identification information for animals may be an apparatus that uploads whether an electronic registration associated with identification information of a target animal has been issued to the first blockchain network 310, and uploads proof information regarding the first NFT generated by being added to the first blockchain network 310 and the identification information of the target animal to the second network 320.

According to an embodiment, the apparatus 200 for providing identification information for animals is a server device, an information processing device, or an information management device, and means an information processing device having a function of providing a predetermined service to the user terminal 400 or the requester terminal 500. The apparatus 200 for providing identification information for animals may be any device as long as the device is an information processing device capable of realizing the functions described in each embodiment. The apparatus 200 for providing identification information for animals may include, by way of example and not limitation, a server device, a computer, a media computer platform, a portable computer device, or another type of computer or communication platform.

The apparatus 200 for providing identification information for animals may transmit, through the communication network 100, a recognition code including access information for the second network 320 to the user terminal 400.

The network database 300 may include the first blockchain network 310 and the second network 320. The first blockchain network 310 may mean a network based on blockchain technology. The first blockchain network 310 may have a structure in which, when a new block is generated, a unique value (hash value) of a previous block is stored. That is, all blocks are connected by hash values, and when a malicious attack occurs, a hash value of a block including information may be changed. In this case, because a hash value of a next block storing the changed hash value is also changed, information security against attacks can be higher. In addition, because the information is shared with all users, recovery can be convenient.

The apparatus 200 for providing identification information for animals may upload whether an electronic registration associated with identification information of a target animal has been issued to the first blockchain network 310, and may upload proof information regarding the first NFT generated by being added to the first blockchain network 310 and the identification information of the target animal to the second network 320, thereby increasing scalability of storage capacity, reducing storage costs, and overcoming limitations of space restrictions.

The user terminal 400 may mean a device of a subject (that is, a user or the like) who receives a recognition code including access information for the second network or receives animal identification information through the apparatus 200 for providing identification information for animals according to an embodiment of the present invention.

The user terminal 400 may be any terminal as long as the terminal is an information processing terminal capable of realizing the functions described in each embodiment. The user terminal 400 may include, by way of example and not limitation, a smartphone, a mobile phone, a desktop computer, a laptop computer, a tablet PC, a PDA (Personal Digital Assistant), a wearable device (such as a smart watch or smart glasses), or another type of computing device.

According to an embodiment, the user terminal 400 may provide, to the apparatus 200 for providing identification information for animals, a request to add identification information of the target animal.

The requester terminal 500 may mean a device of a requester who requests the apparatus 200 for providing identification information for animals to confirm an animal. Specifically, the requester terminal 500 may provide image data of a lost animal to the apparatus 200 for providing identification information for animals.

According to an embodiment, when image data of a lost animal is received from the requester terminal 500, the apparatus 200 for providing identification information for animals may extract feature data of the lost animal.

By way of example, when image data of a lost animal is received from the requester terminal 500, the apparatus 200 for providing identification information for animals may confirm whether an NFT including the feature data exists among a plurality of NFTs stored in the second network 320.

According to an embodiment, when an NFT including the feature data exists in the second network 320, the apparatus 200 for providing identification information for animals may transmit a confirmation message to an owner terminal. That is, through the confirmation message, an owner may be provided with information on a lost animal matching feature data of an animal owned by the owner. The confirmation message may include image data of the lost animal acquired from the requester terminal 500 and requester information.

According to an embodiment, the owner may confirm whether the lost animal matches an animal owned by the owner based on information on the lost animal included in the confirmation message. In addition, when the lost animal is the owner's companion animal, the owner may quickly find the animal using the requester information included in the confirmation message. As described above, the apparatus 200 for providing identification information for animals may quickly provide owner information for a lost animal. Through this, problems such as abandoned animals may also be solved.

According to another embodiment, when no NFT including the feature data exists in the second network 320, an unregistered notification message may be transmitted to the requester terminal 500.

According to another embodiment, the unregistered notification message may include issuance information of an electronic registration associated with identification information of the animal. Through this, an electronic registration for the lost animal may be issued. At the request of the requester terminal, the apparatus 200 for providing identification information for animals may upload information indicating whether an electronic registration associated with identification information of the lost animal has been issued to the predetermined first blockchain network 310, and may upload proof information regarding the first NFT generated by being added to the first blockchain network 310 and the identification information of the lost animal to the predetermined second network 320.

According to an embodiment, the apparatus 200 for providing identification information for animals may provide, to the requester terminal 500, a recognition code including access information for the second network 320. When preparing a notice or announcement regarding a protected animal, the requester may attach the recognition code.

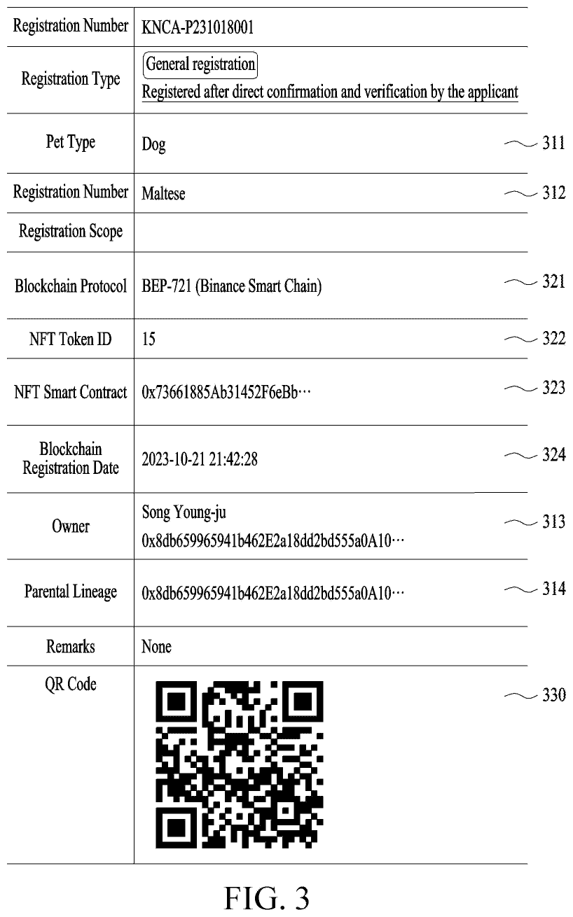

FIGS. 3 to 6 are exemplary diagrams for describing information uploaded to the apparatus for providing identification information for animals according to an embodiment.

FIG. 3 is an exemplary diagram for describing information uploaded to the apparatus for providing identification information for animals according to an embodiment.

Referring to FIG. 3, the apparatus 200 for providing identification information for animals may upload, to the second network 320, identification information 311, 312, 313, and 314 of the target animal classified by a registration number, proof information 321, 322, 323, and 324 regarding the first NFT, and a recognition code 330 including access information for the second network 320.

By way of example, the identification information of the target animal may include at least one of the type 311 and 312 of the target animal, the registered owner 313 of the target animal, the lineage information 308 of the target animal, and image data of the target animal.

Specifically, the type 311 and 312 of the target animal may mean a classification 311 or a breed 312 of the target animal. The registered owner 313 of the target animal may mean the registered owner in the electronic registration of the target animal. That is, information on the registered owner of the target animal may be uploaded to the second network.

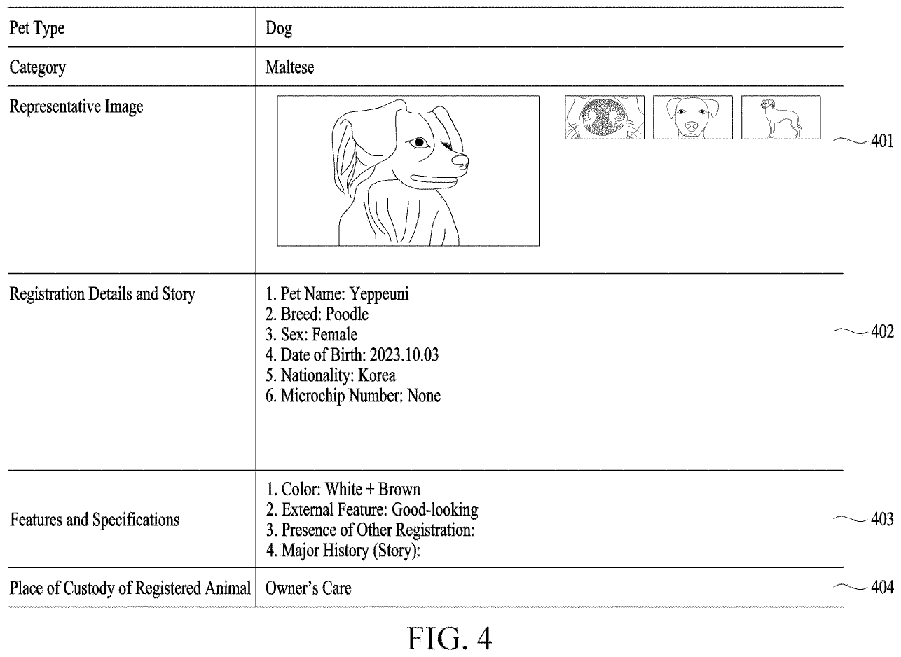

More specifically, referring to FIG. 4, the identification information of the target animal may include image data 401 of the target animal. In addition, the identification information of the target animal may further include story information 402 of the target animal, characteristic information 403 of the target animal, and management information 404 of the target animal.

Specifically, the image data 401 of the target animal may include images of the target animal captured from various angles. In addition, the image data 401 of the target animal may include a nose print image of a dog.

The story information 402 of the target animal may include a date of birth, nationality, microchip number, and the like of the target animal. When microchip information exists in the story information 402 of the target animal, the apparatus 200 for providing identification information for animals may interwork with a national animal protection information system to retrieve registered information.

The characteristic information 403 of the target animal may include external characteristics of the target animal. The characteristic information 403 of the target animal may include scar information or disability information that is difficult to confirm from an image. Through this, identification of the target animal can become more convenient and accurate.

The management information 404 of the target animal may indicate a relationship between the registered owner and the target animal.

Referring again to FIG. 3, the proof information regarding the first NFT may include at least one of protocol information 321 of the first blockchain network, identification information 322 of the first NFT, a smart contract address 323 of the first blockchain network, access information of the first NFT, registration information 324 of the first NFT, and a hash value of the first blockchain network.

Specifically, the protocol information 321 of the first blockchain network may mean a method of connecting respective nodes of coins created based on blockchain technology. The identification information 322 of the first NFT may mean a token ID. Accurate information inquiry may be possible using the token ID. The smart contract address 323 of the first blockchain network may enable a smart contract on the first blockchain network. The registration information 324 of the first NFT may mean a time at which information indicating whether an electronic registration associated with identification information of the target animal has been issued is uploaded to the first blockchain network.

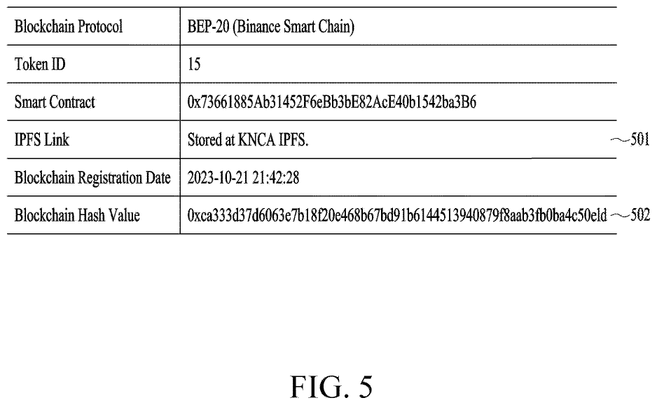

Referring to FIG. 5, the proof information regarding the first NFT may include at least one of protocol information 321 of the first blockchain network, identification information 322 of the first NFT, a smart contract address 323 of the first blockchain network, access information 501 of the first NFT, registration information 324 of the first NFT, and a hash value 502 of the first blockchain network.

According to an embodiment, depending on access authority, the user terminal 400 may access only the protocol information 321, the identification information 322 of the first NFT, the smart contract address 323 of the first blockchain network, and the registration information 324 of the first NFT disclosed in FIG. 3.

According to another embodiment, depending on access authority, the user terminal 400 may access information including the protocol information 321 of the first blockchain network, the identification information 322 of the first NFT, the smart contract address 323 of the first blockchain network, the access information 501 of the first NFT, the registration information 324 of the first NFT, and the hash value 502 of the first blockchain network.

The access information 501 of the first NFT disclosed in FIG. 5 may mean information generated by connecting NFT data to an IPFS (InterPlanetary File System), which is a distributed file storage system. The apparatus 200 for providing identification information for animals may provide an accurate NFT location by uploading an IPFS link.

According to an embodiment, the apparatus 200 for providing identification information for animals may provide the hash value 502 of the first blockchain network. Because all information in the blockchain network is converted and stored based on hash values, the corresponding hash value 502 may be an important factor in information security. Accordingly, the apparatus 200 for providing identification information for animals may set the degree of information disclosure differently according to access authority.

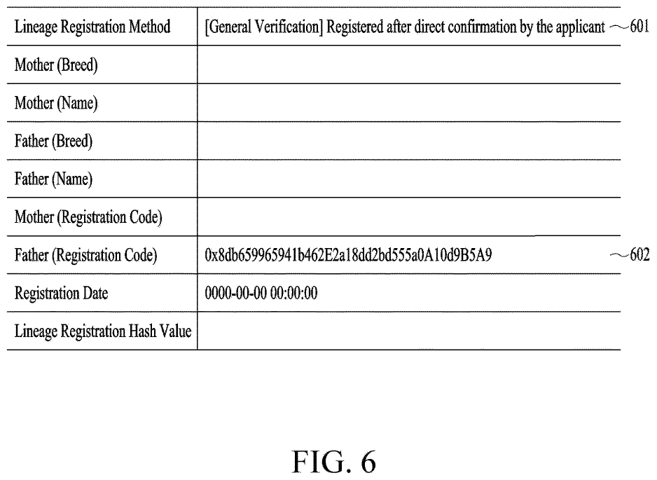

Referring to FIG. 6, the apparatus 200 for providing identification information for animals may provide options so that a pedigree registration method 601 is set differently. The apparatus 200 for providing identification information for animals may upload animal identification information including information on a parent of the target animal.

Specifically, when a registration 602 for a parent of the target animal exists, the apparatus 200 for providing identification information for animals may upload a fact of authentication of information on a parental lineage of the target animal to the first blockchain network. The apparatus 200 for providing identification information for animals may upload, to the predetermined second network, additional proof information regarding the second NFT generated by being added to the first blockchain network and access information for an NFT of a parent of the target animal.

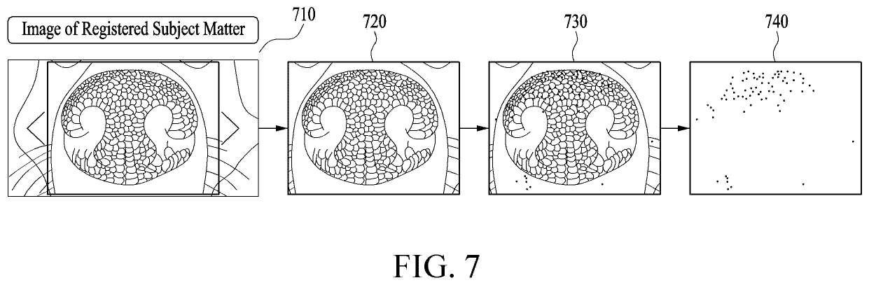

FIG. 7 is an exemplary diagram for describing a step of extracting feature data for an animal according to an embodiment.

Referring to FIG. 7, the apparatus 200 for providing identification information for animals may extract a nose region from an image of a target animal and extract feature points. The apparatus 200 for providing identification information for animals may generate feature data based on the extracted feature points.

According to an embodiment, the apparatus 200 for providing identification information for animals may inquire animal information based on the feature data.

According to an embodiment, the apparatus 200 for providing identification information for animals may extract an image 710 including a nose print from the image data 401 of the target animal stored in the second network.

By way of example, the apparatus 200 for providing identification information for animals may extract a nose region 720 from the image 710 including the nose print. The apparatus 200 for providing identification information for animals may extract feature points by analyzing a histogram of the nose region. The apparatus 200 for providing identification information for animals may generate, as an image, feature data 740 based on an image 730 from which the feature points are extracted.

More specifically, the apparatus 200 for providing identification information for animals may extract a rectangular region of interest from a facial image of the animal and output a histogram of the region of interest. The apparatus 200 for providing identification information for animals may generate feature points corresponding to maximum values or average values for each region in the output histogram. The apparatus 200 for providing identification information for animals may store the generated feature data.

According to an embodiment, when a plurality of images exist, the apparatus 200 for providing identification information for animals may generate final feature data using an average of the respective images. By using a plurality of images, it is possible to reduce the possibility that incorrect information is extracted due to the influence of reflected light caused by camera and light angles during an image acquisition process. In addition, by generating accurate feature data, reliability of animal identification can be increased.

By way of example, when image data of a lost animal is received from a requester terminal, the apparatus 200 for providing identification information for animals may extract a nose region from the received image data, analyze a histogram of the nose region to extract feature points, and determine similarity with final feature data uploaded to the second network. When the similarity is equal to or greater than a predetermined value, the apparatus 200 for providing identification information for animals may determine that the lost animal matches the target animal corresponding to the final feature data. That is, the apparatus 200 for providing identification information for animals may provide a service by transmitting messages to an owner terminal and the requester terminal so that the lost animal can be returned to the owner.

The apparatus described above may be implemented by hardware components, software components, and/or a combination of hardware components and software components. For example, the apparatus and components described in the embodiments may be implemented using one or more general-purpose computers or special-purpose computers, such as a processor, a controller, an ALU (arithmetic logic unit), a digital signal processor, a microcomputer, an FPGA (field programmable gate array), a PLU (programmable logic unit), a microprocessor, or any other device capable of executing and responding to instructions. A processing device may execute an operating system (OS) and one or more software applications executed on the operating system. In addition, the processing device may access, store, manipulate, process, and generate data in response to execution of software. For convenience of understanding, although a single processing device may be described as being used, a person having ordinary skill in the art will appreciate that the processing device may include a plurality of processing elements and/or a plurality of types of processing elements. For example, the processing device may include a plurality of processors or one processor and one controller. Other processing configurations, such as a parallel processor, are also possible.

Software may include a computer program, code, instructions, or a combination of one or more thereof, and may configure the processing device to operate as desired or may instruct the processing device independently or collectively. Software and/or data may be permanently or temporarily embodied in any type of machine, component, physical device, virtual equipment, computer storage medium or device, or transmitted signal wave in order to be interpreted by the processing device or to provide instructions or data to the processing device. Software may be distributed over network-connected computer systems and stored or executed in a distributed manner. Software and data may be stored in one or more computer-readable recording media.

The method according to the embodiments may be implemented in the form of program instructions executable through various computer means and recorded in a computer-readable medium. The computer-readable medium may include program instructions, data files, data structures, and the like alone or in combination. The program instructions recorded on the medium may be specially designed and configured for the embodiments, or may be known and available to those skilled in computer software. Examples of the computer-readable recording medium include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of program instructions include not only machine language code such as that generated by a compiler, but also high-level language code executable by a computer using an interpreter or the like. The above-described hardware devices may be configured to operate as one or more software modules to perform operations of the embodiments, and vice versa.

Although the embodiments have been described above with reference to limited embodiments and drawings, a person having ordinary skill in the art may make various modifications and changes from the above description. For example, even if the described techniques are performed in an order different from the described method, and/or components of the described system, structure, apparatus, circuit, and the like are combined or assembled in a form different from the described method, or replaced or substituted by other components or equivalents, appropriate results may be achieved.

Therefore, other implementations, other embodiments, and equivalents of the claims also fall within the scope of the claims described below.

What is claimed is:

1. A method for providing identification information for animals using a blockchain-based non-fungible token (NFT) performed by a computing device, the method comprising:
uploading information indicating whether an electronic registration associated with identification information of a target animal has been issued to a predetermined first blockchain network;
uploading proof information regarding a first NFT generated by being added to the first blockchain network and the identification information of the target animal to a predetermined second network;
transmitting a recognition code including access information for the second network to a user terminal;
when a registration for a parent of the target animal exists, uploading a fact of authentication of information on a parental lineage of the target animal to the first blockchain network;
uploading additional proof information regarding a second NFT generated by being added to the first blockchain network and access information for an NFT of the parent of the target animal to the predetermined second network; and
uploading lineage information of the target animal classified by a registration number to the second network as identification information of the target animal.

2. The method of claim 1, wherein the proof information regarding the first NFT includes at least one of protocol information of the first blockchain network, identification information of the first NFT, a smart contract address of the first blockchain network, access information for the first NFT, registration information of the first NFT, and a hash value of the first blockchain network, and
wherein the identification information of the target animal includes at least one of a type of the target animal, a registered owner of the target animal, lineage information of the target animal, and image data of the target animal.
